(19) United States
(12) Patent Application Publication
(10) Pub. No.: US 2013/0077445 A1
(43) Pub. Date: Mar. 28, 2013

(54) ANALOG BEAMFORMER OF ULTRASONIC DIAGNOSIS APPARATUS

(71) Applicants: Ji Yong UM, Pohang-si (KR); Hong June PARK, Pohang-si (KR); Jae Hwan KIM, Gyeongju-si (KR)

(72) Inventors: Ji Yong UM, Pohang-si (KR); Hong June PARK, Pohang-si (KR); Jae Hwan KIM, Gyeongju-si (KR)

(73) Assignee: POSTECH ACADEMY- INDUSTRY FOUNDATION, Pohang-si (KR)

(21) Appl. No.: 13/620,128

(22) Filed: Sep. 14, 2012

(30) Foreign Application Priority Data
Sep. 22, 2011 (KR) 10-2011-0095906

(51) Int. Cl. H04B 1/16

(52) U.S. Cl. 367/135

(57) ABSTRACT

An analog beamformer of an ultrasonic diagnosis apparatus includes: a plurality of unit analog beamformers allocated to two or more focal points, respectively, and configured to beamform signals received from the respective focal points through transducer elements and output the beamformed signals; an analog multiplexer configured to sequentially select the output signals of the unit analog beamformers and generate a final output signal; a clock generator configured to provide a clock signal required for the unit analog beamformers; and a processor configured to provide information on sampling time points of channels, and sequentially operate the unit analog beamformers to perform beamforming according to a time-interleaving scheme.

### FIELD OF THE INVENTION

The present invention relates to an ultrasonic diagnosis apparatus, and more particularly, to an analog beamformer of an ultrasonic diagnosis apparatus.

### DESCRIPTION OF THE RELATED ART

Currently, a digital beamformer is frequently used as a beamformer of a receiver of an ultrasonic diagnosis apparatus.

Since the digital beamformer can use a relatively complex and precise algorithm to implement a beamforming operation in a digital area, the digital beamformer has significantly contributed to improving the quality of an ultrasonic image.

Recently, an interest and demand for ultrasonic 3D images has rapidly increased.

In order to implement a 3D image, a 2D transducer is required. When digital beamforming is used, the hardware size of a beamformer to support such a 2D transducer may be excessively increased.

In particular, the digital beamformer must convert an analog echo signal of each channel into a digital signal, in order to perform beamforming and signal processing. Therefore, an analog-to-digital converter (ADC) is necessarily used for each channel.

When the 2D transducer is used to acquire a 3D image (for example, 32×32 channels), the same number of ADCs as the channel number are required. Therefore, the size and complexity of the hardware used for beamforming may increase to an unmanageable level.

In order to overcome such a problem, a method of performing beamforming in an analog domain has been proposed.

The analog beamforming is performed as follows: analog echo signals of channels are delayed during different times for the respective channels, values sampled in the respective channels at a specific common time point are added in an analog manner to perform beamforming, and the analog signals subjected to the beamforming are converted into digital signals through ADCs.

The above-described method may effectively reduce the size of the hardware, because the number of ADCs in a receiver of an ultrasonic diagnosis apparatus may be reduced.

Furthermore, when an ultrasonic transducer probe may perform analog beamforming, the number of wires connecting the probe to the main body may also be significantly reduced. Therefore, in the case of a 256-channel 1D transducer or 2D transducer having a large number of channels, the analog beamforming is more effective than the digital beamforming in terms of hardware.

The analog beamforming method must properly delay the echo signals of the respective channels during different times depending on the channels and add the delayed signals. Therefore, the performance of a delay line used for delaying the analog signals of the respective channels is very important.

At the initial stage when the ultrasonic diagnosis apparatus was developed for the first time, a digital beamformer was not used, but an analog beamformer using a tapped LC delay line was used.

In order for the tapped LC delay line to precisely control delay, the number of taps must be increased, and a multiplexer and a control circuit for controlling the taps become very complex.

Furthermore, since received signals are selected at different tap positions for the respective channels, an insertion loss caused by the tapped LC delay line may differ depending on the respective channels.

In order to solve the above-described problem, a beamforming method which does not used the tapped LC delay line but uses a sample/hold (hereinafter, referred to as S/H) circuit using a capacitor has been proposed.

FIG. 1 is a block diagram of a conventional analog beamformer using S/H circuits. FIG. 2 is a detailed circuit diagram of a delay element of FIG. 1. FIG. 3 is a diagram illustrating a focusing delay profile for an arbitrary focal point and time points at which sampling is performed in the delay element of FIG. 2.

Referring to FIG. 1, the conventional analog beamformer 10 includes a control processor 10, a plurality of delay elements 12 corresponding to the number of channels, and an analog adder 13.

Referring to FIG. 2, the delay elements 12 use a plurality of S/H circuits to differently set a hold time corresponding to a difference between a sampling time point and a read-out time point, thereby differently setting signal delay times of the respective channels.

The control processor 11 controls the delay times of the respective delay elements 12 using a stall signal. The output signals of the respective delay elements 12 are added by the analog adder 13 and then outputted as a final output signal.

As illustrated in FIG. 2, each of the delay elements 12 includes a plurality of sample switches 12a, a plurality of read-out switches 12b, a plurality of sample capacitors 12c, a charge integrator 12d, and two first and second shift registers 12e and 12f.

The sample switches 12a of the respective sample capacitors 12c are controlled by the first shift register 12e, and the read-out switches 12b are controlled by the second shift register 12f.

In the first shift register 12e, only one output (output of the leftmost D flip-flop) is set to 1 and the other outputs are set to 0, at the initial stage when a power supply voltage is connected.

When a system clock signal is applied, the position of the output 1 is shifted from the leftmost D flip-flop to a D flip-flop in the right side at each rising edge time of the system clock signal.

An analog input is sampled by the sample capacitors 12c. As logic 1 is shifted in the first shift register 12e to drive the sample switches 12a, the respective capacitors 12c sequentially perform the sampling operation.

As logic 1 is shifted in the second shift register 12f to drive the read-out switches 12b, the read-out operations of the respective capacitors 12c are performed.

The second shift register 12f performs the initial value setting and the shifting operation for logic 1 in the same manner as the first shift register 12e.

However, although the first shift register 12e controls the shift of logic 1 according to only the system clock signal, the second shift register 12f may also control the shift of logic 1 according to the stall signal outputted by the control processor 11 of FIG. 1 as well as the system clock signal.

That is, during a time period when the stall signal is maintained at logic 1, the operation of the second shift register 12f to shift logic 1 is not performed even at a rising edge time of the system clock signal. Accordingly, the hold time increases until the sampled analog signals are read out.

According to the above-described method, the analog input is regularly sampled, and the hold times are controlled differently for the respective channels using the stall signal. Therefore, the delay value of the analog input may be differently set for the respective channels.

The analog voltage of the sample capacitor 12c of which the read-out switch 12b is turned on is outputted by the charge integrator 12d.

At this time, since the charge integrator 12d is required for each of the delay elements 12, the same number of op-amplifiers as the channel number are required.

FIG. 3 illustrates relative delay differences between channels when echo signals generated from one focal point reach transducer elements of the respective channels.

Since ultrasonic transmission paths from the one focal point to the respective channels are different from each other, the echo signals leaving the one focal point at the same time reach the respective channels at different time points.

Adding the echo signals reaching the respective channels at different time points to add the echo signals leaving the one focal point at the same time is the aim of beamforming performed by the receiver of the ultrasonic diagnosis apparatus.

FIG. 3 is a curve indicating the time points when the echo signals leaving the one focal point at the same time reach the respective channels, illustrating a focusing delay profile. The focusing delay profile indicates delay differences between channels.

In FIG. 3, a vertical dotted line indicates a time point when a sampling operation is performed at each channel (a rising edge time of the system clock signal in FIG. 2).

That is, the sampling operation is regularly performed at each period T_{S} of the clock signal, and controlled by the operation of the first shift register 12e.

In FIG. 3, a small arrow (t) at each channel indicates a sampling time of the channel with respect to an echo signal generated at the focal point.

According to the operation of the delay element 12 of FIG. 2, the sampling operations are regularly performed at each period T_{S} at the respective channels, and the read-out operations are simultaneously performed in all of the channels at a time point when the sampling operation is completed at a channel where an echo signal arrives latest.

Since the sampling operation is regularly performed at each integer multiple time of the clock signal period T_{S}, a focusing delay error may occur between the focusing delay profile and the regular sampling times.

In FIG. 3, the delay control resolution is set to T_{S}. Typically, T_{S} is set to ¼ of the period of an ultrasonic carrier signal.

The focusing delay error caused by the regular sampling operations as illustrated in FIG. 3 may cause incorrect reception beamforming of the beamformer. Accordingly, the signal-to-noise ratio (SNR) may be reduced.

### SUMMARY OF THE INVENTION

Accordingly, the present invention has been made in an effort to solve the problems occurring in the related art, and an object of the present invention is to provide an analog beamformer of an ultrasonic diagnosis apparatus, which operates a plurality of unit analog beamformers according to a time-interleaving scheme, thereby reducing the number of op-amplifiers required for the analog beamformer.

Another object of the present invention is to provide an analog beamformer of an ultrasonic diagnosis apparatus, which is capable of reducing a focusing delay error and widening a sampling time control range.

In order to achieve the above object, according to one aspect of the present invention, there is provided an analog beamformer of an ultrasonic diagnosis apparatus including: a plurality of unit analog beamformers allocated to two or more focal points, respectively, and configured to beamform signals received from the respective focal points through transducer elements and output the beamformed signals; an analog multiplexer configured to sequentially select the output signals of the unit analog beamformers and generate a final output signal; a clock generator configured to provide a clock signal required for the unit analog beamformers; and a processor configured to provide information on sampling time points of channels, and sequentially operate the unit analog beamformers to perform beamforming according to a time-interleaving scheme.

### BRIEF DESCRIPTION OF THE DRAWINGS

The above objects, and other features and advantages of the present invention will become more apparent after a reading of the following detailed description taken in conjunction with the drawings, in which:

FIG. 1 is a block diagram of a conventional analog beamformer using S/H circuits;

FIG. 2 is a detailed circuit diagram of a delay element of FIG. 1;

FIG. 3 is a diagram illustrating a focusing delay profile for an arbitrary focal point and time points at which sampling is performed in the delay element of FIG. 2;

FIG. 4 is a diagram for explaining an analog beamformer operating according to a time-interleaving scheme, in accordance with an embodiment of the present invention;

FIG. 5 is a block diagram of the analog beamformer operating according to the time-interleaving scheme in accordance with the embodiment of the present invention;

FIG. 6 is a detailed block diagram of a unit analog beamformer in accordance with the embodiment of the present invention;

FIG. 7 is a timing diagram of the unit analog beamformer of FIG. 6;

FIG. 8 is a block diagram of a circuit for generating a sampling clock signal of a 16th channel in the unit analog beamformer; and

FIG. 9 is a timing diagram of the circuit illustrated in FIG. 8.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

The following embodiments may be implemented by combining components and features of the present invention into a specific form. The respective components or features may be considered to be selective, as long as separate explicit descriptions are not made. The respective components or features may be implemented in a form that is not coupled to other components or features. Furthermore, some components and/or features may be combined to implement the embodiments of the present invention. The sequence of operations described in the embodiments of the present invention may be changed.

Furthermore, some components or features of any one embodiment may be included in another embodiment, or replaced with corresponding components or features of another embodiment.

In the drawings, procedures or steps which may obscure the purpose of the present invention are not described, and procedures or steps which may be easily understood by those skilled in the art are not described, either.

In the entire specification, when a certain part “comprises” or “includes” a certain component, it means that the certain part does not exclude other components but may further comprise or include other components, as long as specific explanations are not made. Furthermore, terms such as “˜unit”, “˜er”, and “˜module” described in the specification mean a unit to process one or more functions or operations, and the unit may be implemented by hardware, software, or a combination of hardware and software. Furthermore, “a or an”, “one”, “the”, and related terms may be used as a meaning that includes a singular form and plural forms, as long as they are not indicated differently in contexts describing the present invention (in particular, contexts of claims) or not clearly refuted by contexts.

Specific terms used in the embodiments of the present invention are provided to help understanding of the present invention, and may be changed into other forms without departing from the scope and spirit of the invention.

Hereafter, the embodiments of the present invention will be described in detail with reference to the accompanying drawings. The detailed descriptions which will be disclosed below with the accompanying drawings are made to explain exemplary embodiments of the present invention, and do not indicate only an embodiment of the present invention.

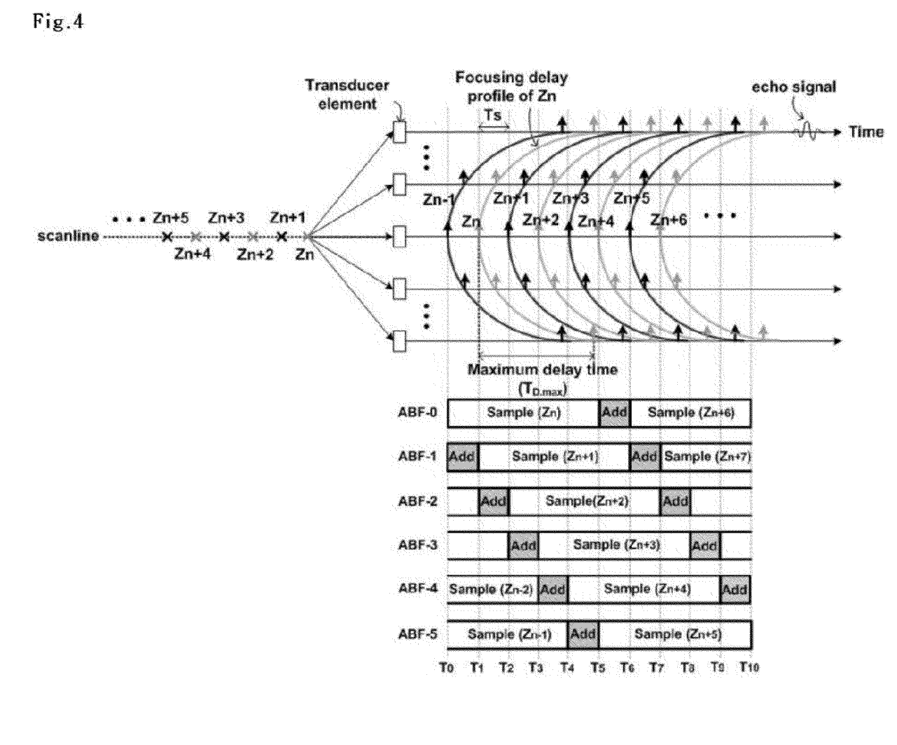

FIG. 4 is a diagram for explaining an analog beamformer operating according to a time-interleaving scheme, in accordance with an embodiment of the present invention. Referring to FIG. 4, distances from focal points

Zₙ₊₅, . . . on one scan line to channels are different from each other. Therefore, echo signals generated from one focal point at the same time are received by the respective channels at different time points.

A focusing delay profile is a curve indicating different reception time points of the respective channels with respect to one focal point. FIG. 4 illustrates focusing delay profiles for the respective focal points Zₙ₊₅, . . . .

At this time, small arrows (↑) on each of the focusing delay profiles indicate sampling time points of the respective channels with respect to echo signals generated from a corresponding focal point.

In order for the respective channels to sample and add the echo signals generated from the respective focal points according to the focusing delay profiles, a waiting time is required until a sampling operation is performed at a channel where an echo signal is received latest, after a sampling operation is performed at a channel where an echo signal is received first on the respective focusing delay profiles.

At this time, a channel where the sampling operation is completely performed on a received echo signal on a focusing delay profile for a corresponding focal point receives an echo signal generated from the next focal point on the scan line. Therefore, before the sampling operation of the channel where the echo signal is received latest on the focusing delay profile of the corresponding focal point, the echo signal generated from the next focal point may be sampled.

In order to solve the above-described problem, one unit analog beamformer may be allocated to each focusing delay profile so as to perform an operation of sampling and adding all echo signals of the corresponding focusing delay profile, which are received by all the channels.

That is, echo signals generated from one focal point (for example, Zₙ) at the same time are received by the respective channels at different time points, and the respective channels sample the received echo signals at different time points according to the corresponding focusing delay profile, using one unit analog beamformer (for example, ABF-0). Then, after the sampling operations are completed at all the channels, the analog addition operation is performed.

Furthermore, an operation of sampling and adding echo signals generated from the next focal point Zₙ₊₁ is performed in the same manner by the next unit analog beamformer ABF-1.

When the plurality of unit analog beamformers are operated according to the time-interleaving scheme, beamforming operations for the focal points which are sequentially positioned on the scan line may be sequentially performed.

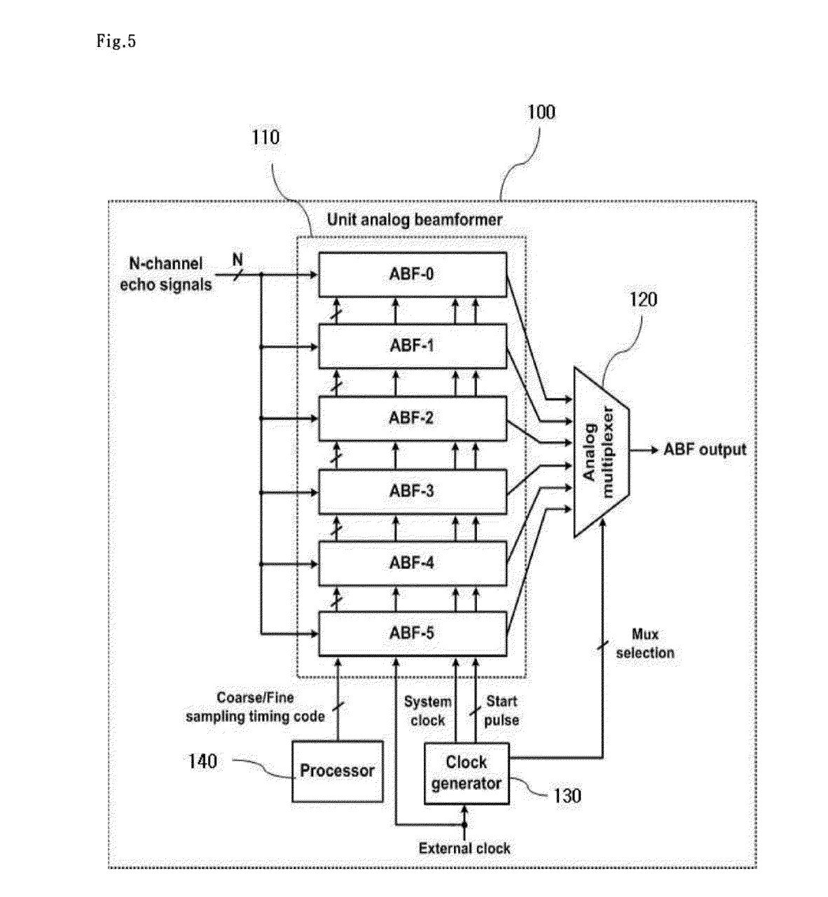

For this operation, referring to FIG. 5, the respective unit analog beamformers ABF-0, ABF-1, ABF-5 are connected to all the channels, and echo signals received by the respective channels at time points indicated by small arrows (t) on a focusing delay profile of FIG. 4 are sampled by a corresponding unit analog beamformer.

For example, the unit analog beamformer ABF-0 managing the focal point Zₙ samples echo signals received by the respective channels at time points indicated by small arrows (↑) on the focusing delay profile corresponding to the focal point Zₙ of FIG. 4 from a time point T₀, and performs an addition operation during one period Tₛ after all sampling operations are completed at a time point T₅.

At this time, a time from the time point T₀ to the time point T₁ is used as a time which is required for the unit analog beamformer ABF-0 to acquire an echo signal of a channel where the echo signal is first sampled.

The unit analog beamformer ABF-0 processes echo signals corresponding to a focal point Zₙ₊₆ from a time point T₆ after completing the beamforming operation for the corresponding focal point Zₙ.

Similarly, the unit analog beamformer ABF-1 processes echo signals corresponding to a focal point Zₙ₊₁ from the time point T₁ after one period T_{S}.

Similarly, the unit analog beamformers ABF-2, ABF-3, ABF-4, and ABF-5 process echo signals corresponding to focal points Zₙ₊₂, Zₙ₊₃, Zₙ₊₄, and Zₙ₊₅, respectively.

In FIG. 4, the time point T₆ when the echo signals corresponding to the focal point Zₙ₊₆ start to be received corresponds to a time point when the unit analog beamformer ABF-0 completely outputs a result value after sampling and adding the echo signals corresponding to the focal point Zₙ.

Therefore, the unit analog beamformer ABF-0 may be used for processing the echo signals corresponding to the focal point Zₙ₊₆.

Similarly, echo signals received from focal points Zₙ₊₇, Zₙ₊₉, Zₙ₊₁₀, and Zₙ₊₁₁ positioned farther from the transducer elements of the respective channels are processed by the unit analog beamformers ABF-1, ABF-2, ABF-3, ABF-4, and ABF-5, respectively.

As such, the plurality of unit analog beamformers (six analog beamformers in FIG. 4) simultaneously operate in parallel at one time point.

In FIG. 4, six unit analog beamformers are connected to all the channels perform the sampling operation and the analog addition operation at time points designated by the processor 140 of FIG. 5.

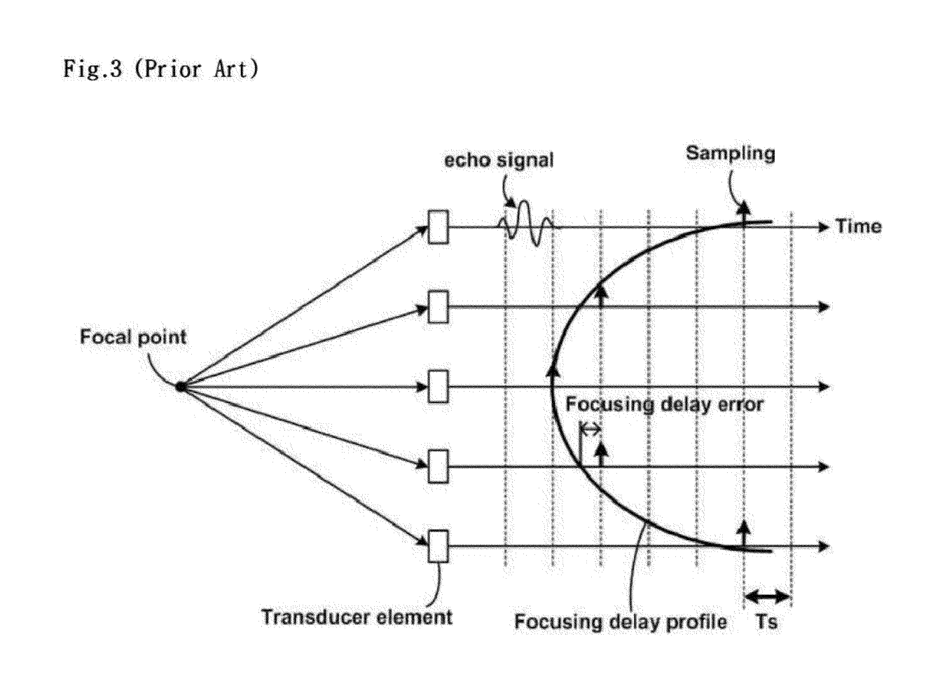

That is, since the conventional analog beamformer illustrated in FIG. 3 performs a sampling operation only at integer multiple time points of the period T_{S}, the focusing delay error is relatively large.

As illustrated in FIG. 4, however, the analog beamformer in accordance with the embodiment of the present invention may set the sampling time resolution to 10 ns or less instead of the integer multiple time points of the period T_{S}, thereby reducing a focusing delay error.

As described above, echo signals generated from one focal point are received by the respective channels at different time points. Therefore, there exists a case in which a difference in reception time point between the first-received echo signal and the latest-received echo signal in the transducer elements becomes the largest.

When the maximum value T_{D.max} of differences in reception time point between the respective echo signals is divided by the sampling period Tₛ of the transducer elements connected to the scan line and two is added to the value obtained by the division, the resultant numerical value corresponds to the minimum number of unit analog beamformers required by the analog beamformer in accordance with the embodiment of the present invention.

That is, the minimum number of unit analog beamformers required by the analog beamformer in accordance with the embodiment of the present invention may be calculated according to Equation 1 below.

$$NmberofABF \frac{{T}_{D \cdot max}}{{T}_{S}} + 2 \qquad [ Equation 1 ]$$

At this time, each of the unit analog beamformers 110 operating according to the time-interleaving scheme requires a time corresponding to one period T_{S} to perform an addition operation and a time corresponding to one period T_{S} to acquire the echo signal of the channel where the sampling operation is first performed. Therefore, a constant 2 is added to Equation 1 as described above.

In principle, a focal point where the delay difference becomes the maximum value T_{D.max} is positioned the closest to the transducer elements on the scan line.

At this time, in order to reduce the maximum value T_{D.max}, only echo signals received by some transducer elements are beamformed for the focal point close to the transducer elements on the scan line (dynamic aperture).

That is, the dynamic aperture increases the number of transducer elements used in the beamforming, as the transducer elements become remote from the focal point.

When the dynamic aperture is used, a focal point where all of the transducer elements start to be used for beamforming exists among the focal points on the scan line, and the maximum value T_{D.max} of the analog beamformer 100 in accordance with the embodiment of the present invention is decided by the focusing delay profile of the focal point.

In this embodiment of the present invention, the dynamic aperture is used to reduce the maximum value T_{D.max} of the analog beamformer 100 to a range of several ns to several hundred us.

FIG. 5 is a block diagram of the analog beamformer operating according to the time-interleaving scheme in accordance with the embodiment of the present invention.

When the maximum value T_{D.max} is about 4Tₛ as illustrated in FIG. 4, six unit analog beamformers are necessary. FIG. 5 illustrates a case in which six unit analog beamformers 110 are used.

As illustrated in the timing diagram of FIG. 4, the addition results of the respective unit analog beamformers 110 are sequentially outputted at corresponding periods T_{S}. An analog multiplexer 120 of FIG. 5 sequentially selects the output signals of the respective unit analog beamformers 110 and outputs the final result value.

The processor 140 is configured to provide a coarse/fine sampling timing code, which is information on the sampling time points of the respective channels, to the respective analog beamformers 110. Furthermore, the processor 140 sequentially operates the unit analog beamformers 110 to perform beamforming according to the time-interleaving scheme.

A clock generator 130 is configured to provide start pulses-n (n=0, . . . , 5) corresponding to the respective unit analog beamformers 110 to the unit analog beamformers 110, and provide a MUX selection signal of the analog multiplexer 120.

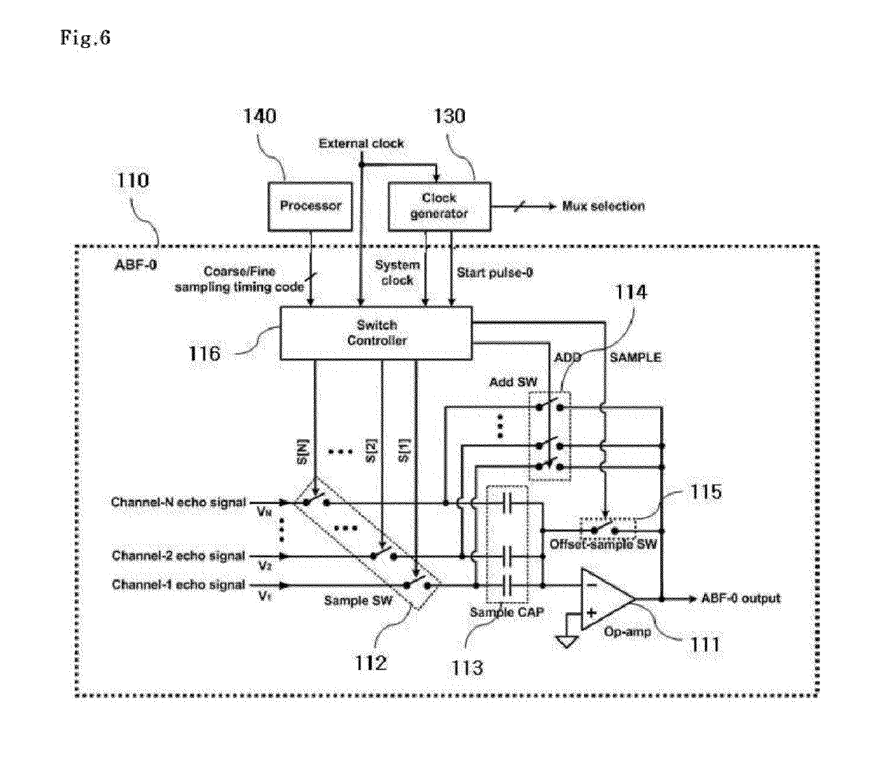

FIG. 6 is a detailed block diagram of the unit analog beamformer ABF-0 in accordance with the embodiment of the present invention.

Referring to FIG. 6, the unit analog beamformer 110 includes a sample/add (hereafter, referred to as ‘S/A’) circuit and a switch controller 116. The S/A circuit is configured by combining an S/H circuit and an analog adder.

The S/A circuit includes an op-amplifier 111, a plurality of sample switches 112, a plurality of sample capacitors 113, a plurality of add switches 114, and an offset-sample switch 115. The op-amplifier 111 is configured to add the sampled signals from the transducer elements and output the addition result.

The sample switches 112 have one sides connected to the respective transducer elements. The sample capacitors 113 are connected between the other sides of the sample switches 112 and an inverting node (−) of the op-amplifier 111. The add switches 114 have one sides connected between the other sides of the sample switches 112 and the sample capacitors 113 and the other sides connected to an output terminal of the op-amplifier 111. The offset-sample switch 115 has one side connected between the sample capacitors 113 and the inverting node (−) of the op-amplifier 111 and the other side connected to the output terminal of the op-amplifier 111.

Furthermore, the switch controller 116 is configured to control switching operations of the sample switches 112, the add switches 114, and the offset-sample switch 115, and control falling times of sampling clock signals S[1], . . . , S[N] of the respective channels, according to the control of the processor 140 and the clock generator 130.

At this time, the numbers of the sample switches 112, the sample capacitors 113, and the add switches 114 are respectively equal to the number of the transducer elements.

The offset-sample switch 115 is used for sampling an offset voltage of the op-amplifier 111.

Immediately after the S/A circuit starts to operate, all of the sample switches 112 are turned on according to the control of the switch controller 116, and the offset-sample switch 115 positioned on a feedback path of the op-amplifier 111 is also turned on.

The echo signals of the channels connected to the respective transducer elements are sampled when the sample switches 112 are turned off. In this case, according to the control of the switch controller 116, a sample switch of a channel where the sampling operation is first performed on the corresponding focusing delay profile is first turned off, and a sample switch of a channel where the sampling operation is latest performed on the corresponding focusing delay profile is latest turned off.

The switch controller 116 turns off the sample switches 112 and the offset-sample switch 115 when the sampling operations of the respective channels are completed. At this time, the switch controller 116 sets an off time of the offset-sample switch 116 to an integer multiple time of the period T_{S}, and turns off the offset-sample switch 116 at the integer multiple time of the period T_{S}.

Accordingly, the sampling period of the unit analog beamformer 110 (sampling period of FIG. 4) is ended, and an addition period is then performed during the period T_{S}.

The switch controller 116 turns on the add switches 114 connected to the respective sample capacitors 113 during the addition period, and the terminal connected to the channels of the sample capacitors 113 is connected to the output terminal of the op-amplifier 111.

At this time, analog voltages sampled by the respective sample capacitors 113 are added and averaged and then used as an output of the op-amplifier 111 as expressed by Equation 2 below.

$${V}_{op \text{-} amp} = \frac{{V}_{1} + {V}_{2} + 0 + {V}_{N}}{N} \qquad [ Equation 2 ]$$

In Equation 2, Vₒₚ₋ₐₘₚ represents an output voltage of the op-amplifier 111, and Vᵢ represents an echo voltage sampled at an i-th channel. Since the channel number is N, the op-amplifier 111 outputs a voltage obtained by dividing voltages by N.

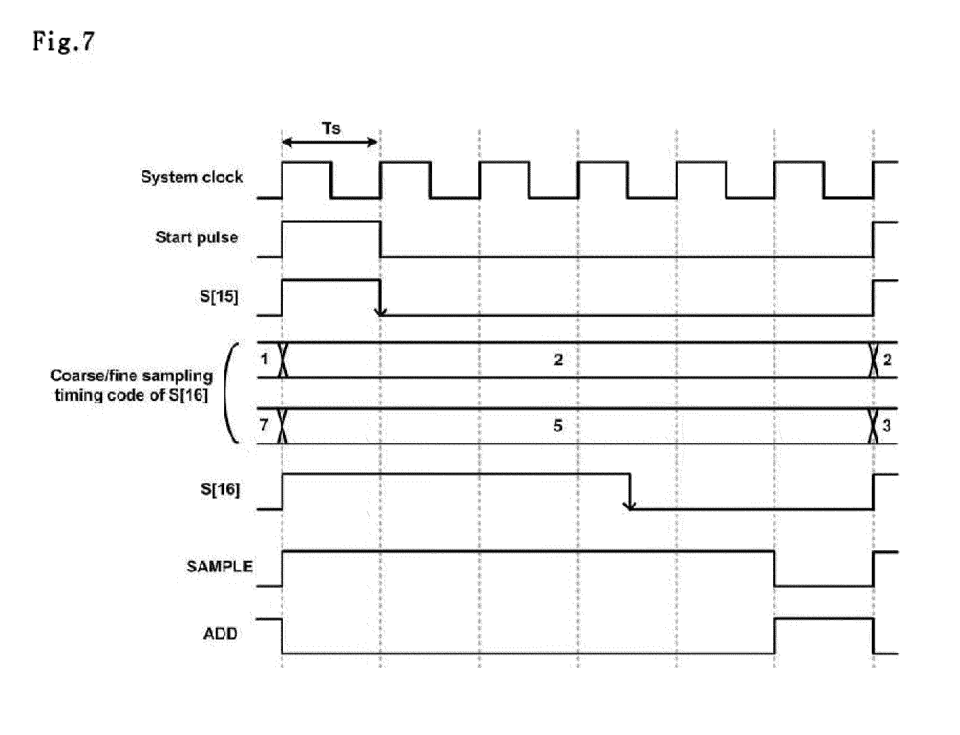

FIG. 7 is a timing diagram of the unit analog beamformer ABF-0 of FIG. 6.

Referring to FIG. 7, a transducer element located on the scan line, among all the transducer elements, has the fastest sampling time. In FIG. 7, suppose that a channel where the transducer element located on the scan line is positioned is a 15th channel.

The start pulse-0 is a signal synchronized with the system clock signal. A sampling clock signal S[15] of the 15th channel changes from logic 0 to logic 1 at a rising edge time of the start pulse-0. After logic 1 is maintained during the period T_{S}, the sampling clock signal S[15] changes from logic 1 to logic 0 at a falling edge time of the start pulse-0.

While the sampling clock signal S[15] maintains logic 1 during the period T_{S}, an echo signal of the 15th channel is acquired, and then sampled at the falling edge time of the sampling clock signal S[15].

Furthermore, a sampling time of another transducer element (for example, 16th channel) is based on the sampling time of the transducer element corresponding to the 15th channel, and may be decided by adding the coarse/fine sampling timing code provided from the processor 140.

Referring to FIG. 5, the processor 140 transfers a new coarse/fine sampling timing code to the respective unit analog beamformers 110 at every 6T_{S} in this embodiment of the present invention in which six unit analog beamformers 110 are operated in parallel.

A sample signal SAMPLE is a signal which turns on the offset-sample switch 115 during the sample period to compensate for an input offset voltage of the op-amplifier 111 illustrated in FIG. 6 such that the input offset voltage of the op-amplifier 111 is sampled in the sample capacitors 113.

The sample signal SAMPLE changes from logic 0 to logic 1 at the rising edge of the start pulse-0, and maintains logic 1 during 5T_{S} until the sampling operations of all the channels are completed.

After the sampling operations of all the channels are completed, the sample signal SAMPLE changes from logic 1 to logic 0.

An add signal ADD is a signal for adding echo signals of all the channels, which are sampled during the sample period of 5T, and maintains logic 1 only during one period T, after the sample signal SAMPLE changes from logic 1 to logic 0.

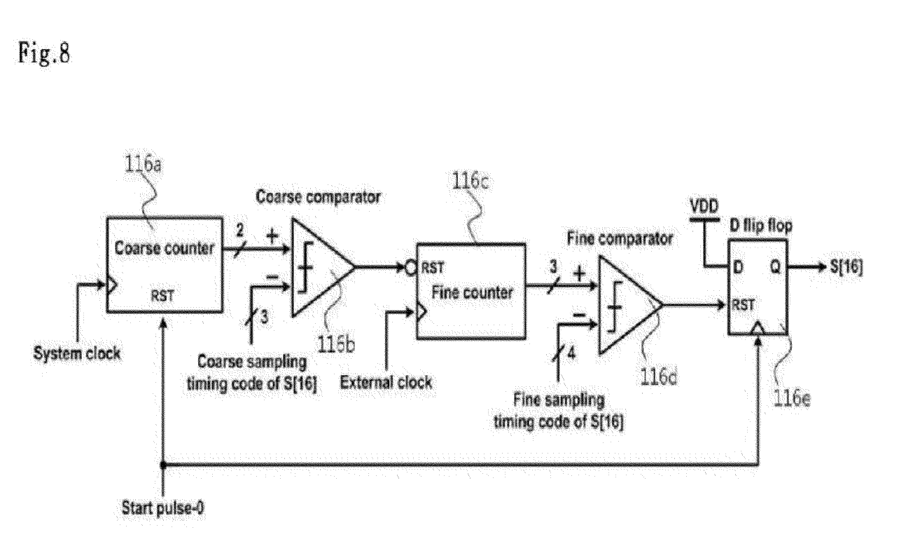

FIG. 8 is a block diagram of a circuit for generating a sampling clock signal of the 16th channel in the unit analog beamformer ABF-0.

The circuit illustrated in FIG. 8 is included in the switch controller 116 illustrated in FIG. 6.

The circuit illustrated in FIG. 8 includes a coarse counter 116a, a coarse comparator 116b, a fine counter 116c, a fine comparator 116d, and a D flip-flop 116e.

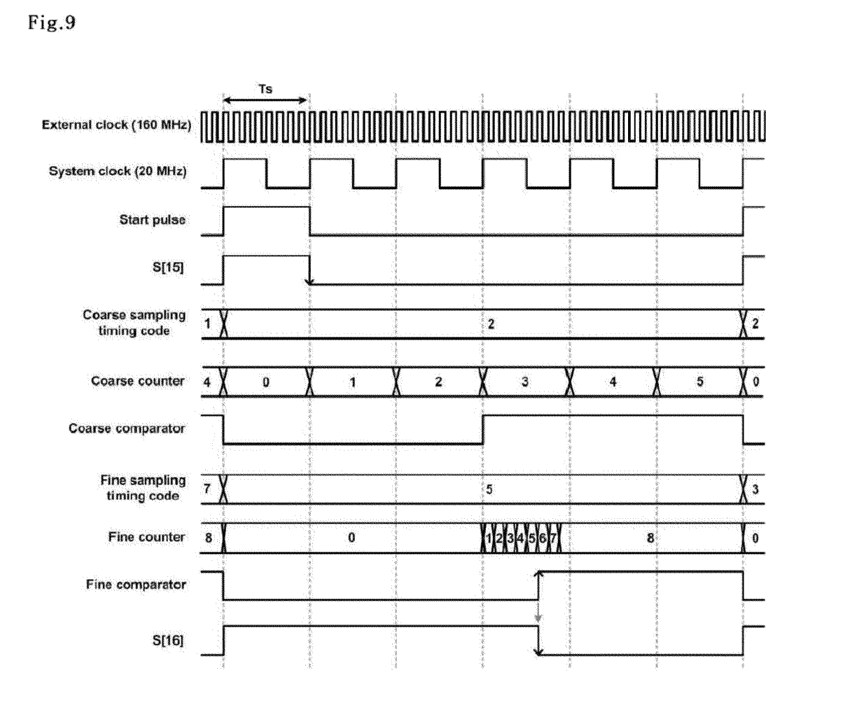

FIG. 9 is a timing diagram of the circuit illustrated in FIG. 8.

Referring to FIGS. 8 and 9, the coarse counter 116a is driven according to a system clock signal, and the fine counter 116c is driven according to an external clock signal.

At this time, suppose that the transducer element located on the scan line corresponds to the 15th channel, and the 16th channel is a channel adjacent to the 15th channel.

In this case, the sampling clock signal S[15] of the 15th channel is the same signal as the start pulse-0.

A sampling clock signal S[16] of the 16th channel changes from logic 0 to logic 1 at the rising edge time of the start pulse-0, and a falling edge time thereof is decided according to the coarse/fine sampling code provided from the processor 140.

That is, the coarse/fine sampling timing code of the sampling clock signal S[16] indicates a time difference between the sampling time (falling edge time) of the sampling clock signal S[16] and the sampling time (falling edge time) of the sampling clock signal S[15].

The start pulse-0 is a signal to announce the operation start of the unit analog beamformer ABF-0 illustrated in FIG. 5, and is maintained to logic 1 during one period T_{S} of the system clock signal. For reference, the start pulses-n (n=0, . . . , 5) allocated to the respective unit analog beamformer 110 are sequentially delayed by the time T_{S}, and the period thereof is 6T_{S} (six unit analog beamformers operate in parallel).

For example, the start pulse-0 is a signal allocated to the unit analog beamformer ABF-0, and a signal delayed by the time T_{S} from the start pulse-0 is applied as the start pulse-1 to the analog beamformer ABF-1.

The start pulses-n (n=1, . . . , 5) are supplied to the respective unit beamformers 110 from the clock generator 130.

The sampling clock signal S[16] changes from logic 0 to logic 1 at the rising edge time of the start pulse-0, and the coarse counter 116a starts up counting from the falling edge time of the start pulse-0.

The coarse comparator 116b is configured to compare the coarse sampling timing code of the 16th channel, received from the processor 140, to the output code of the coarse counter 116a.

At this time, when the output code of the course counter 116 is larger than the coarse sampling timing code according to the comparison result of the coarse comparator 116b, the output signal of the coarse comparator 116b changes from logic 0 to logic 1, and the fine counter 116c starts up counting according to the output signal.

When the output code of the fine counter 116c is larger than the fine sampling timing code of the 16th channel, an output signal of the fine comparator 116d becomes logic 1, the sampling clock signal S[16] of the 16th channel becomes logic 0, and this time point becomes the sampling time point of the 16th channel.

In FIG. 8, in order to increase a sampling time control range of a sampling clock signal for a specific channel, the bit number of the coarse counter 116a may be increased.

At this time, the maximum value of the sampling time control range is obtained by multiplying an input clock period of the coarse counter 116a and the maximum count value of the coarse counter 116a.

FIG. 9 is a timing diagram of the circuit of FIG. 8, in which the unit analog beamformer ABF-0 generates the sampling clock signal S[16] of the 16th channel.

For example, suppose that the channel number N is set to 32 and the scan line is located at a channel positioned in the center (for example, 15th channel).

An echo signal generated from a focal point located on the scan line is first received by the 15th channel positioned in the center among the plurality of channels, and a falling edge of the sampling clock signal S[15] of the channel occurs at each specific integer multiple time of the period T_{S} according to the system clock signal such that the sampling operation is performed.

In FIG. 9, when the start pulse-0 is first applied, the rising edge of the sampling clock signal S[15] occurs, and the falling edge of the sampling clock signal S[15] occurs after the time T_{S}.

A rising edge of the sampling clock signal S[16] of the 16th channel occurs at the rising edge of the start pulse-0 in the same manner as the sampling clock signal S[15], and a falling edge of the sampling clock signal S[16] occurs at the rising edge time of the output signal of the fine comparator 116d.

From the falling edge time of the start pulse-0, the coarse counter 116a starts up counting using the system clock signal (clock signal obtained by dividing an external clock signal of 160 MHz by 8 in FIG. 9).

When the output signal of the coarse counter 116a becomes larger than the coarse sampling timing code of the 16th channel, the output signal of the coarse comparator 116d changes from logic 0 to logic 1. From this time point, the fine counter 116c starts up counting using an external clock signal.

The fine comparator 116d compares the output code of the fine counter 116c to the fine sampling timing code of the 16th channel, and the sampling clock signal S[16] changes from logic 1 to logic 0 at the rising edge time of the output signal of the fine comparator 116d. At the falling edge time of the sampling clock signal S[16], the echo signal is sampled at the 16th channel.

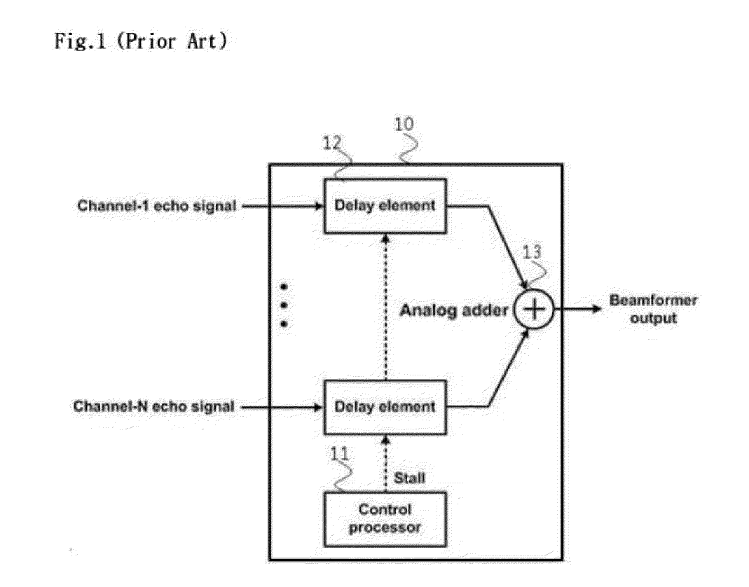

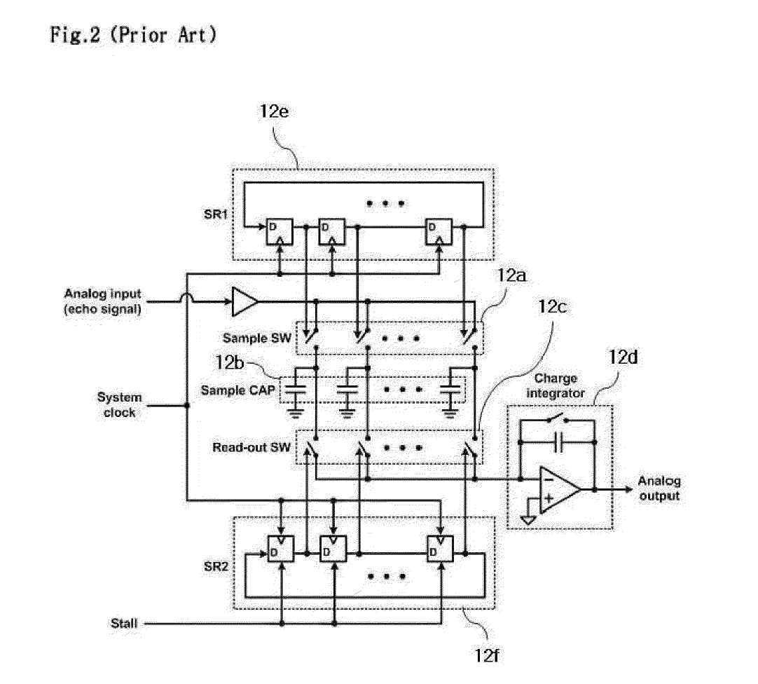

In order to compare the analog beamformer apparatus 100 in accordance with the embodiment of the present invention to the conventional analog beamformer apparatus 10 using the delay elements having S/H circuits embedded therein as illustrated in FIGS. 1 to 3, suppose that an equal number of focal points exist on the scan line.

Table 1 comparatively shows the hardware and performance of the analog beamformer apparatus 100 in accordance with the embodiment of the present invention and the hardware and performance of the conventional analog beamformer apparatus 10.

TABLE 1

| | Conventional analog | |
|---|---|---|
| | beamformer using relay | Analog beamformer of |
| | element (S/H array) | this work |
| Number of op-amps | N | $E \frac{{T}_{D \cdot max}}{{T}_{S}} + 1$ |
| Number of capacitors | $ENY \{ \frac{{T}_{D \cdot max}}{{T}_{S}} + 1 \}$ | $ENY \{ \frac{{T}_{D \cdot max}}{{T}_{S}} + 1 \}$ |
| Max. focusing delay error | T_{S} | $\frac{{T}_{S}}{{D}_{ratio}}$ |

Referring to Table 1, T_{S} represents a system clock period which is equal to the sampling period of the transducer elements positioned on the scan line.

Dᵣₐₜᵢₒ represents a divide ratio of the system clock signal, and N represents the number of transducer elements (channels).

At this time, in the analog beamformer apparatus 100 in accordance with the embodiment of the present invention, T_{S} is 50 ns (20 MHz), N is 32, Dᵣₐₜᵢₒ is eight, T_{D.max} is 197 ns, and the maximum focusing delay error is 6.25 ns. On the other hand, in the conventional analog beamformer apparatus 10, the maximum focusing delay error is 50 ns. Accordingly, it can be seen that the performance of the analog beamformer apparatus 100 in accordance with the embodiment of the present invention is more excellent than the conventional analog beamformer apparatus.

In accordance with the embodiments of the present invention, the analog beamformer of the ultrasonic diagnosis apparatus provides the following effects.

First, the analog beamformer operates the plurality of unit analog beamformer according to the time-interleaving scheme, and thus may reduce the number of op-amplifiers required for the analog beamformer when the number of unit analog beamformers is smaller than the number of channels, because each of the unit analog beamformer requires one op-amplifier.

Second, since the analog beamformer uses a digital high or low-speed counter, the analog beamformer may wide the sampling time control range, and reduce the focusing delay error.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. An analog beamformer of an ultrasonic diagnosis apparatus, comprising:
a plurality of unit analog beamformers allocated to two or more focal points, respectively, and configured to beamform signals received from the respective focal points through transducer elements and output the beamformed signals;
an analog multiplexer configured to sequentially select the output signals of the unit analog beamformers and generate a final output signal;
a clock generator configured to provide a clock signal required for the unit analog beamformers; and
a processor configured to provide information on sampling time points of channels, and sequentially operate the unit analog beamformers to perform beamforming according to a time-interleaving scheme.

2. The analog beamformer of claim 1, wherein the number of the unit analog beamformers corresponds to a numerical value obtained by dividing a maximum value of differences in reception time point between signals received from a corresponding focal point by a sampling period of the transducer elements and adding two to the division result.

3. The analog beamformer of claim 2, wherein the unit analog beamformers beamform only a part of signals received from a focal point close to the transducer elements among the focal points, in order to reduce the maximum value.

4. The analog beamformer of claim 1, wherein, when the transducer elements completely sample signals received from a corresponding focal point, the unit analog beamformer adds the sampled signals in an analog manner.

5. The analog beamformer of claim 4, wherein the respective transducer elements sample the signals received within 5 ns from time points when the signals are received from the corresponding focal point.

6. The analog beamformer of claim 4, wherein the unit analog beamformer comprises:
an op-amplifier configured to add the signals sampled by the transducer elements and output the addition result;
a plurality of sample switches having one sides connected to the respective transducer elements;
a plurality of sample capacitors connected between the other sides of the sample switches and an inverting node of the op-amplifier;
a plurality of add switches having one sides connected between the other sides of the sample switches and the sample capacitors and the other sides connected to an output terminal of the op-amplifier;
an offset-sample switch having one side connected between the capacitors and the inverting node of the op-amplifier and the other side connected to the output terminal of the op-amplifier; and
a switch controller configured to control switching operations of the sample switches, the add switches, and the offset sample switch.

7. The analog beamformer of claim 6, wherein the switch controller periodically turns off the sample switches of channels connected to the scan line at each time period corresponding to a value obtained by multiplying the period of a system clock signal and the number of unit analog beamformers, such that a difference between an offset voltage of the op-amplifier and an echo signal received from the focal point at a channel where the echo signal is first received is sampled by the sample capacitors.

8. The analog beamformer of claim 7, wherein the switch controller receives a digital code corresponding to a relative difference between time points at which the echo signals generated from the focal point reach the respective channels, and controls off time points of the sample switches according to the digital codes of the respective channels based on the sample time point of the channel where the echo signal is first received, such that differences between the offset voltage of the op-amplifier and the echo signals received from the focal point are sampled in the respective sample capacitor.

9. The analog beamformer of claim 8, wherein the switch controller controls the switching operations of the add switches and the offset-sample switch such that the voltages sampled in the sample capacitors are transferred to the output terminal of the op-amplifier to add and output the sampled voltages.
